(19) United States
(12) Patent Application Publication
(10) Pub. No.: US 2023/0291213 A1
(43) Pub. Date: Sep. 14, 2023

(54) CLIMATE-CONTROLLED BATTERY CHARGING CONTAINER

(71) Applicants: Leland D. Black, Panguitch, UT (US); Craig Roundy, Parowan, UT (US); Anthony Barlow, Cedar City, UT (US)

(72) Inventors: Leland D. Black, Panguitch, UT (US); Craig Roundy, Parowan, UT (US); Anthony Barlow, Cedar City, UT (US)

(21) Appl. No.: 18/181,702

(22) Filed: Mar. 10, 2023

Related U.S. Application Data
(60) Provisional application No. 63/319,202, filed on Mar. 11, 2022.

(51) Int. Cl. H02J 7/00; F25D 11/00; G01K 1/08

(52) U.S. Cl. CPC H02J 7/0042; F25D 11/00; G01K 1/08

(57) ABSTRACT

A climate-controlled battery charging container includes an insulated housing, a heated panel, and a plurality of power outlets. The insulated housing may further include a base, a hinged lid removably couplable to the base, one or more handles, one or more wheels, a thermostat, a temperature gauge, a first power switch, and a second power switch. In some examples, the climate-controlled battery charging container also features a cooled panel, an intake vent, at least one fan, and a liquid cooling system. The climate-controlled battery charging container enables a user to charge and maintain a battery regardless of ambient temperature ranges including extreme cold and heat.

### CROSS-REFERENCE TO RELATED APPLICATIONS

This application claims the benefit of U.S. Provisional Application Ser. No. 63/319,202, filed on Mar. 11, 2022, which is incorporated herein by reference.

### TECHNICAL FIELD

The present disclosure relates to battery storage containers. More particularly, the present disclosure relates to a heated and cooled battery charging and storage container.

### BACKGROUND

Batteries operate over a wide temperature range; however, both lifespan and charging rate are adversely affected under extreme cold and high heat conditions. Charge acceptance, in particular, is reduced as temperatures approach freezing and is often completely prevented thereafter. While older Nickel and Lead-acid batteries performed at extended temperature bandwidths, modern Lithium-ion batteries exchanged fast, reliable charging for narrower functional ranges. Regardless, the internal resistance of all batteries rises when cold, noticeably prolonging charge times and reducing battery life.

High-temperature charging, by comparison, also reduces optimal charging times, impairs battery functions, and may contribute to thermal runaway—a chain reaction caused by overheating that can result in ignition or even explosion. As batteries cycle through charging at high temperatures, charge acceptance declines. Additionally, prolonged exposure to heat reduces longevity of the battery and, in the case of Lithium-ion batteries, may lead to explosive reactions that release toxic and flammable gases.

For example, construction workers regularly use cordless power tools that use Lithium-ion batteries or similar. Many construction workers are unaware that consumer-grade lithium-ion batteries cannot be charged below 0° C. (32° F.). Although the battery pack appears to be charging normally, plating of metallic Lithium occurs on the anode during a sub-freezing charge that leads to a permanent degradation in performance and safety. Many workers forget to take their batteries into a house or other heated environment at the end of the workday, exposing their batteries to these temperature pitfalls. In areas where it freezes, workers may return to the jobsite the next day to discover that their batteries fail to hold a charge. Similarly, many professionals across various industries experience loss of functionality in their power tools and electronics during the winter season, as well as summer heatwaves.

Accordingly, there is a need for a battery housing that can both protect batteries from high and low temperatures and that is also capable of charging the batteries at the same time. The present disclosure seeks to solve these and other problems.

### SUMMARY OF EXAMPLE EMBODIMENTS

In some embodiments, a climate-controlled battery charging container comprises an insulated housing, a heated panel, and a plurality of power outlets. The insulated housing may comprise a base, a hinged lid removably couplable to the base, one or more handles, one or more wheels, a thermostat configured to adjust an internal temperature within the climate-controlled battery charging container via the heated panel, a temperature gauge, a first power switch, and a second power switch.

In some embodiments, a climate-controlled battery charging container further comprises a cooled panel, an intake vent, at least one fan, and a liquid cooling system. The liquid cooling system is configured to transfer and distribute heat from within the insulated housing. The liquid cooling system may comprise plate and frame, shell and tube, or other alternative structures of heat exchangers.

### BRIEF DESCRIPTION OF THE DRAWINGS

FIG. 1 illustrates a front, top perspective view of a climate-controlled battery charging container;

FIG. 2 illustrates a front elevation view of a climate-controlled battery charging container;

FIG. 3 illustrates an internal perspective view of a climate-controlled battery charging container storing a tool;

FIG. 4 illustrates a partial side elevation view of an electrical plug accessible through the climate-controlled battery charging container;

FIG. 5 illustrates a bottom plan view of a heated panel comprising a plurality of heating elements;

FIG. 6 illustrates an internal perspective view of a climate-controlled battery charging container;

FIG. 7 illustrates an internal perspective view of a climate-controlled battery charging container according to some embodiments;

FIG. 8 illustrates an internal perspective view of a climate-controlled battery charging container having a liquid cooling system;

FIG. 9A illustrates a side elevation view of a fan and radiator of a climate-controlled battery charging container; and

FIG. 9B illustrates a side perspective view of a fan and radiator of a climate-controlled battery charging container.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a charging station that is not affected by the external temperature. Indeed, there is a need for an insulated housing that can both protect batteries from high and low temperatures and that is also capable of charging batteries at the same time. The climate-controlled battery charging container disclosed herein solves these problems and others.

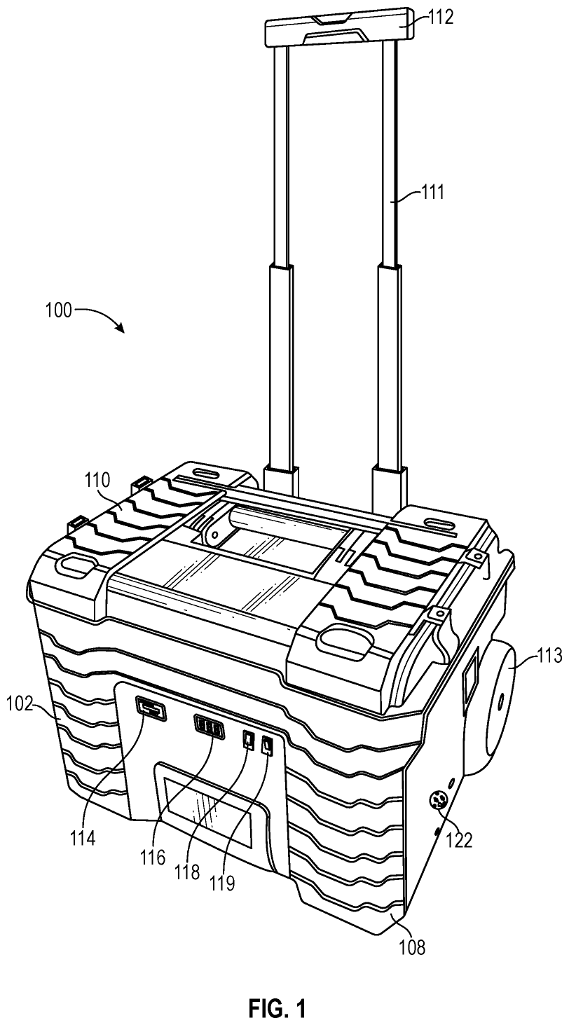

In some embodiments, as shown in FIGS. 1-3, a climate-controlled battery charging container 100 comprises an insulated housing 102, a heated panel 104, and a plurality of power outlets 106. The insulated housing 102 may comprise a base 108, a hinged lid 110 removably couplable to the base 108, one or more handles 112, one or more wheels 113, a voltmeter 114, a temperature gauge/thermostat 116, a first power switch 118, and a second power switch 119.

The insulated housing 102 may be manufactured from polyurethane, extruded polystyrene, cellulose, fiberglass, or alternative insulators having a low thermal conductivity. In some embodiments, said insulators may be pressure injected into a mold of the base 108 to fill in any gaps between an internal frame and an external frame. The hinged lid 110 may comprise gaskets or other sealants made from silicon or rubber configured to firmly secure the hinged lid 110 to the base 108. The hinged lid may also comprise latches, clamps, or alternative fastening mechanisms to further weatherproof the climate-controlled battery charging container 100 and prevent ambient external air from entering.

The one or more handles 112 may be coupled to a center of the hinged lid 110, a first and second side of the base 108, or along any other external surface of the climate-controlled battery charging container 100. The one or more handles 112 may comprise a retractable arm 111 that conveniently telescopes between a collapsed, storage configuration and an extended configuration to assist in transportation. The one or more wheels 113 may be coupled to the base 108, for example, along rear corners to provide maneuverability when the user tilts the climate-controlled battery charging container 100 backwards and pulls the one or more handles 112.

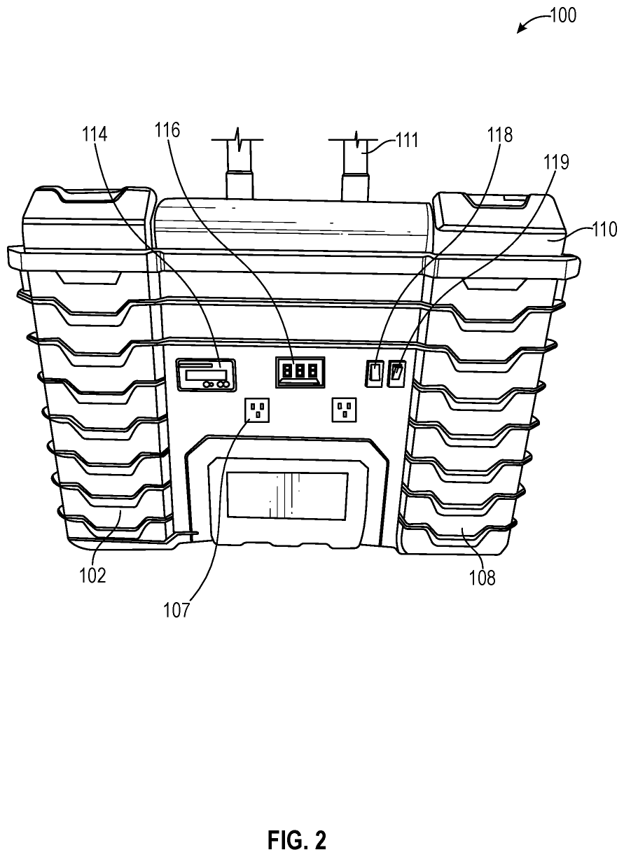

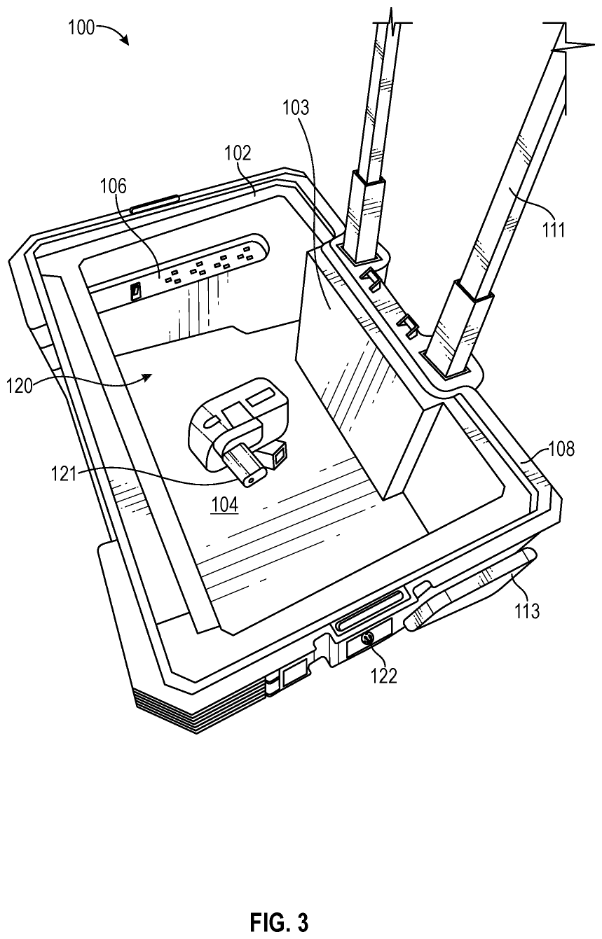

In some embodiments, as best seen in FIGS. 2-3, the thermostat 116 may be configured to adjust an internal temperature 120 within the climate-controlled battery charging container 100 via the heated panel 104. In a preferred embodiment, though without limitation, the internal temperature 120 may range between 85-90° F. or between 72-90° F. It will be appreciated that maintaining the above ranges for the internal temperature 120 extend a charge of the climate-controlled battery charging container 100 by reducing power consumption due to short thermal cycling periods. Other internal temperatures 120, however, between 32-113° F. may be used that permit charging and operation of a power tool battery 121.

The thermostat 116 may enable the user to regulate the internal temperature 120 at different times and days according to a scheduled timer. In some embodiments, the thermostat 116 may be in communication with an application on the user's personal device or a remote control that enables the user to remotely regulate the internal temperature 120 of the climate-controlled battery charging container 100. For example, the thermostat 116 may comprise a thermistor configured to measure electrical resistance changes in response to temperature oscillations and a microcontroller configured to convert that input to a value in Fahrenheit or Celsius representative of the internal temperature 120. The thermostat 116 may comprise an analog or digital temperature gauge that displays the internal temperature 120 within the climate-controlled battery charging container 100. The first power switch 118 may be configured to turn the thermostat 116 on and off, thereby conserving power when not in use. The second power switch 119 may be configured to turn the plurality of power outlets 106 within or without the climate-controlled battery charging container 100 on and off.

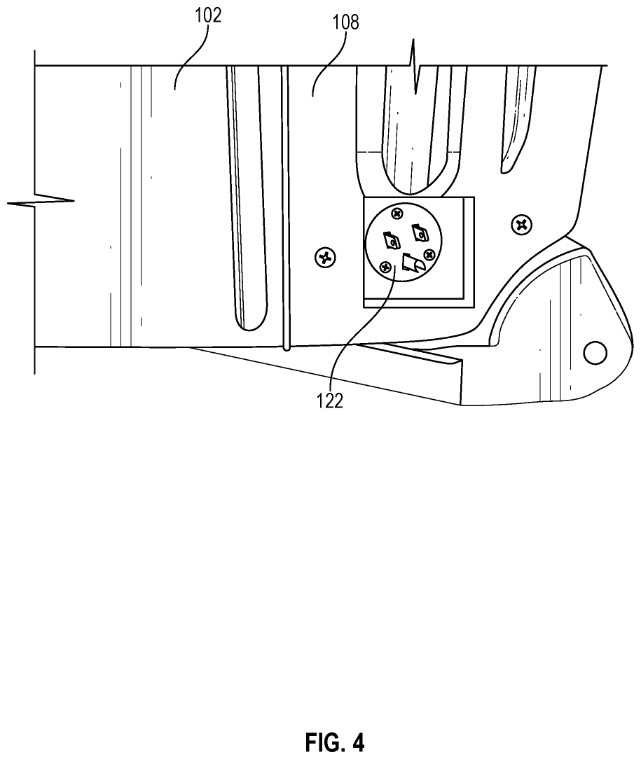

As shown in FIG. 4, the climate-controlled battery charging container 100 may further comprise an external power plug 122. The external power plug 122 may comprise an extension cord to allow the external power plug 122 to be extended from within the insulated housing 102 and couplable to a wall outlet. In some embodiments, when plugged in to a power source (e.g., wall outlet), the external power plug 122 may provide power to one or more power outlets 106 on the interior of the insulated housing 102. This allows a user to plug-in chargers or other equipment within the insulated housing 102. In some embodiments, the insulated housing 102 further comprises an internal battery compartment 103 (FIG. 3) storing internal batteries. The internal batteries located within the battery compartment 103 may be used to provide power to the power outlets 106, such as by using an inverter. In some embodiments, a DC to DC battery charger may be used to charge power tool batteries 121 within the insulated housing 102 using the internal batteries in the internal battery compartment. A benefit of the internal batteries is the ability to charge power tool batteries 121 when grid power may not be available.

In some embodiments, as shown in FIG. 5, the heated panel 104 may be a floor panel, though the heated panel 104 may also be a lid panel, one or more side panels, or combinations thereof. The heated panel 104 may comprise aluminum, plexiglass, padding, or any other sufficiently rigid and strong material such as high-strength plastic, metal, and the like that also allows for high efficiency thermal conductivity. The heated panel 104 may comprise at least one heating element 124 coupled in direct physical contact together or separated by ambient air within the climate-controlled battery charging container 100. The at least one heating element 124 may thereby transfer heat via conduction or convection to either the heated panel 104 or the ambient air. The at least one heating element 124 may comprise ceramic, aluminum, quartz or other conductors configured in wires, plates, and alternative form factors along a bottom surface of the heated panel 104. The at least one heating element may be powered using internal batteries within the internal battery compartment 103 or may be powered using the external power plug 122. Additionally, in some embodiments, the heated panel 104 may comprise inductive charging, whereby a power tool battery 121 may be configured to charge using electromagnetic induction when positioned on the heated panel 104.

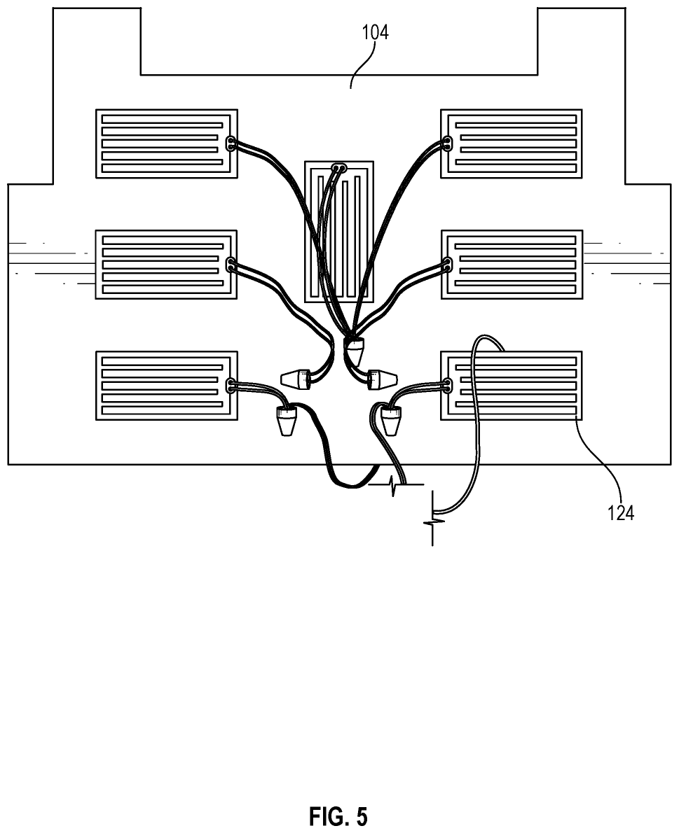

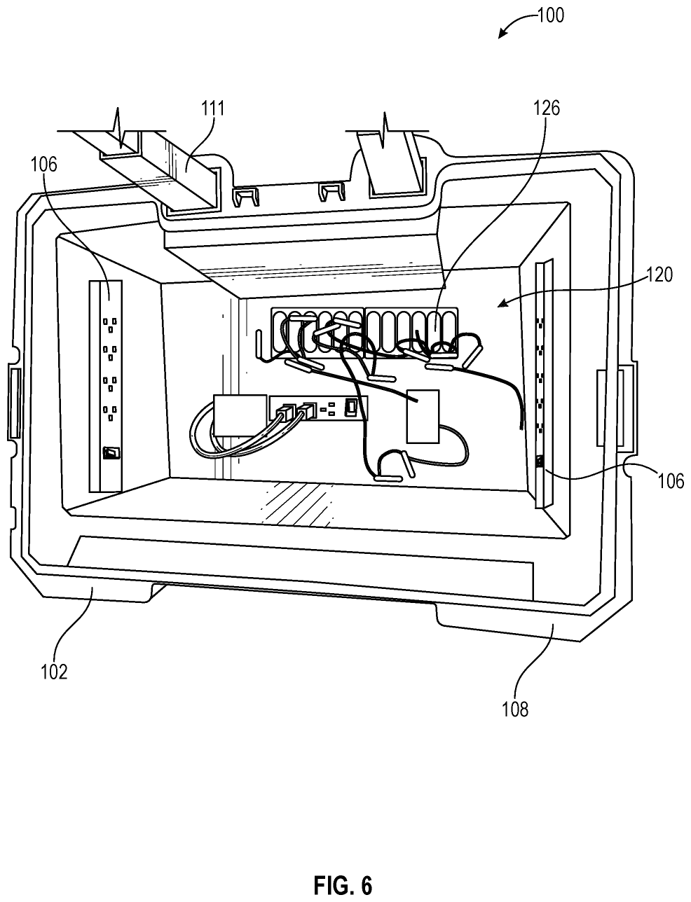

In some embodiments, as shown in FIG. 6, the at least one heating element 124 may be coupled by electrical wiring to a power supply 126 (e.g., rechargeable battery pack) receivable under the heated panel 104. Electricity required for the at least one heating element 124 and the plurality of power outlets 106 may be drawn from the power supply 126 within the climate-controlled battery charging container 100. The plurality of power outlets 106 may be mounted to a side panel of the base 108 or any surface of an interior or an exterior of the climate-controlled battery charging container 100. For example, the user may both charge the power tool battery 121 via one of the plurality of power outlets 106 on the interior of the climate-controlled battery charging container 100 while also charging their personal electronic device, such as a cell phone, via one or more exterior power outlets 107 (FIG. 2).

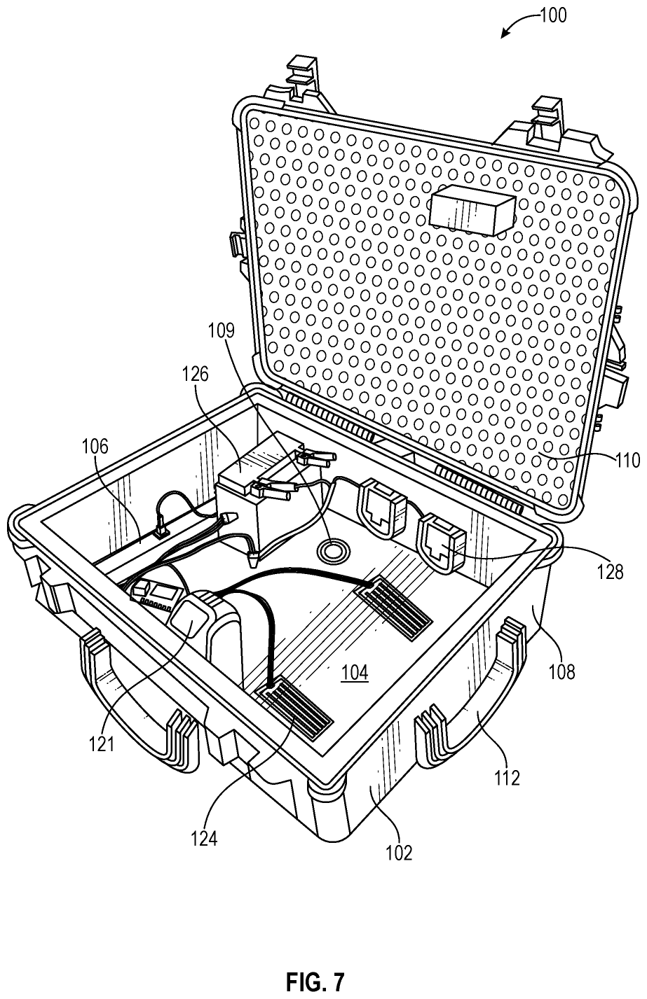

In some embodiments, as shown in FIG. 7, the power supply 126 (e.g., larger battery) may be couplable to a charging station 128 for the power tool battery 121. As shown, the insulated housing 102 may comprise insulation along a bottom of the hinged lid 110, as well as the interior of the climate-controlled battery charging container 100. It will be appreciated that the insulation is a thermally resistant barrier which, in combination with the sealant on the hinged lid 110, inhibits the migration of thermal energy into and out of the insulated housing 102. As shown, the insulated housing 102 may be in varying form factors without departing herefrom. Additionally, as shown in FIG. 7, the heated panel 104 may be transparent, allowing a user to see the components thereunder, such as heating elements 124 or inductive chargers 109, allowing for ease of placement of items on the heated panel 104.

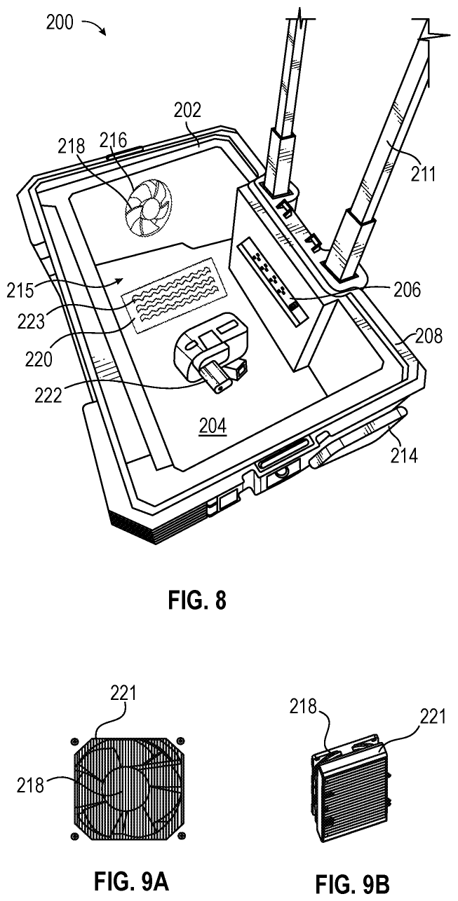

In some embodiments, as shown in FIG. 8, a climate-controlled battery charging container 200 comprises an insulated housing 202, a cooled panel 204, and a plurality of power outlets 206. The insulated housing 202 may comprise a base 208, a hinged lid removably couplable to the base 208, one or more handles, one or more wheels 214, a thermostat configured to adjust an internal temperature 215 within the climate-controlled battery charging container 200 via the cooled panel 204, a temperature gauge, a first power switch, and a second power switch. The climate-controlled battery charging container 200 may further comprise an intake vent 216, at least one fan 218, and a liquid cooling system 220. The liquid cooling system 220 may be configured to transfer and distribute heat from within the insulated housing 202 using a radiator 221 (FIGS. 9A-9B) coupled to the fan 218, with liquid lines 223 extending across the cooled panel 204 and coupled to the radiator 221, allowing for the cooling of the liquid therein and thereby cooling the cooled panel 204. The liquid cooling system 220 may also comprise plate and frame, shell and tube, and related structures of heat exchangers.

In some embodiments, for example, the at least one fan 218 may blow air over the radiator 221, thereby cooling the liquid circulating therethrough before it passes to the cooled panel 204 once again in liquid lines 223. In other words, the cooled panel 204 may function similar to a liquid-cooled heat sink. Additionally, the cooled panel 204 may comprise a Peltier element or cooling fins with a fan blowing over the fins to aid in cooling. It will be appreciated that the liquid cooling system 220 maintains the internal temperature 215 within the climate-controlled battery charging container 200 cool enough to avoid battery functioning issues for a power tool battery 222 such as voltage capacity loss, charging problems, or, in the case of Lithium-ion batteries, explosions due to overheating.

In some embodiments, a climate-controlled battery charging container comprises a thermally-controlled panel capable of heating or cooling the interior of the a climate-controlled battery charging container, depending on the user's selection. In other words, the thermally-controlled panel may comprise heating elements for use when the ambient temperature is too low, but may also comprise a radiator, fans, and/or other components to cool the thermally-controlled panel if the temperature is too high. In some embodiments, rather than a single thermally-controlled panel, a user may remove the heated panel 104 and replace it with a cooled panel 204 or vice versa, depending on the ambient temperature and the desires of the user. As used herein, the term thermally-controlled panel refers to a panel capable of heating, such as the heating panel 104, a panel capable of cooling, such as cooling panel 204, or some combination thereof.

In some embodiments, a method of using a climate-controlled battery charging container 100 comprises actuating a first power switch on an insulated housing 102, heating a heated panel 104 with a heating element 124, and regulating an internal temperature 120 of the insulated housing 102 using a thermostat 116. The method may further comprise charging a power tool battery 121 or other electronic device using a plurality of power outlets 106, 107.

In some embodiments, a method of using a climate-controlled battery charging container 200 comprises cooling an internal temperature 215 of an insulated housing 202 using a liquid cooling system 220 coupled to a cooled panel 204, actuating at least one fan 218, and circulating air and liquid through liquid lines 223.

While the present disclosure specifically addresses battery charging relating to power tools subjected to extreme temperatures, the climate-controlled battery charging container 100, 200 may also be used to maintain medical supplies, construction equipment, paint, roof or flooring preparations, aviation drones, electronics, and other materials at room temperature in a dry, protected environment. For example, a rural veterinarian in the Midwest may maintain medical shots at an appropriate temperature prior to administration to animals on a farm during the winter. In another example, a handyman may maintain caulking agents or paint at an appropriate temperature in preparation for flooring installations and painting projects, respectively. Similarly, an aviation enthusiast may store a small drone within the climate-controlled battery charging container 100, 200 before a flight in inclement weather. Accordingly, it will be appreciated that many materials and items may be desirable to be stored and/or charged at reasonable temperature ranges within the climate-controlled battery charging container 100, 200 for protection against extreme cold and heat.

While the forgoing examples are illustrative of the principles of the present invention in one or more particular applications, it will be apparent to those of ordinary skill in the art that numerous modifications in form, usage, and details of implementation can be made without the exercise of inventive faculty, and without departing from the principles and concepts of the invention.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A climate-controlled battery charging container, comprising:
an insulated housing;
a heated panel positioned inside of the insulated housing;
a plurality of power outlets; and
a power supply.

2. The climate-controlled battery charging container of claim 1, wherein the insulated housing comprises a thermostat configured to adjust an internal temperature within the climate-controlled battery charging container via the heated panel.

3. The climate-controlled battery charging container of claim 1, wherein the insulated housing comprises a temperature gauge.

4. The climate-controlled battery charging container of claim 1, wherein the insulated housing comprises a first power switch configured to turn a thermostat on and off and a second power switch configured to turn the plurality of power outlets on and off.

5. The climate-controlled battery charging container of claim 1, wherein the insulated housing comprises a base, a hinged lid removably couplable to the base, one or more handles, and one or more wheels.

6. The climate-controlled battery charging container of claim 1, wherein the heated panel comprises at least one heating element configured to transfer heat via conduction or convection to air within the climate-controlled battery charging container.

7. The climate-controlled battery charging container of claim 1, wherein an internal temperature of the climate-controlled battery charging container is substantially maintained between 72-90° F. during use.

8. The climate-controlled battery charging container of claim 1, wherein the insulated housing comprises a charging station for a power tool.

9. A climate-controlled battery charging container, comprising:
an insulated housing;
a thermostat;
a thermally-controlled panel positioned within the insulated housing; and
a plurality of power outlets.

10. The climate-controlled battery charging container of claim 9, wherein the insulated housing comprises a first power switch configured to turn the thermostat on and off and a second power switch configured to turn the plurality of power outlets on and off.

11. The climate-controlled battery charging container of claim 9, wherein the insulated housing comprises a base, a hinged lid removably couplable to the base, one or more handles, and one or more wheels.

12. The climate-controlled battery charging container of claim 9, wherein an internal temperature of the climate-controlled battery charging container is substantially maintained between 72-90° F. during use.

13. The climate-controlled battery charging container of claim 9, wherein the insulated housing comprises a charging station for a power tool.

14. A climate-controlled battery charging container, comprising:
an insulated housing;
a heated panel;
a cooled panel; and
a plurality of power outlets.

15. The climate-controlled battery charging container of claim 14, further comprising a liquid cooling system.

16. The climate-controlled battery charging container of claim 14, further comprising an intake vent.

17. The climate-controlled battery charging container of claim 14, further comprising at least one fan.

18. The climate-controlled battery charging container of claim 14, wherein the insulated housing comprises a thermostat configured to adjust an internal temperature within the climate-controlled battery charging container via the cooled panel or heated panel.

19. The climate-controlled battery charging container of claim 14, wherein the insulated housing comprises a first power switch configured to turn the thermostat on and off and a second power switch configured to turn the plurality of power outlets on and off.

20. The climate-controlled battery charging container of claim 14, wherein the insulated housing comprises a base, a hinged lid removably couplable to the base, one or more handles, and one or more wheels.
